(19) United States
(12) Patent Application Publication
(10) Pub. No.: US 2011/0298755 A1
(43) Pub. Date: Dec. 8, 2011

(54) MATRIX SENSOR

(76) Inventor: Yang Ni, Palaiseau (FR)

(21) Appl. No.: 13/139,567

(22) PCT Filed: Dec. 16, 2009
(86) PCT No.: PCT/IB09/55788

§ 371 Date: Aug. 25, 2011

(30) Foreign Application Priority Data
Dec. 16, 2008 (FR) 08 58628
Mar. 5, 2009 (FR) 09 51393

(51) Int. Cl. G06F 3/042; G01J 1/42

(52) U.S. Cl. 345/175; 250/208.2

(57) ABSTRACT

The present invention relates to a matrix optical sensor including:
a matrix of pixels (6ᵢⱼ), each pixel (6ᵢⱼ) being identified by a row address and a column address; and
a plurality of programmable units for reading the pixels (6ᵢⱼ), each connected to at least one column of pixels and each being configured:
   to enable storage of at least one row address during a step of programming the sensor (1);
   to receive a row address; and
   for some read address values, to compare the received row address to the programmed row address, and if they are equal to enable reading of the value of the corresponding pixel (6ᵢⱼ).

The present invention relates to matrix optical sensors.

The invention is applied, for example, to the use of such sensors to detect an object in the image of a detection plane on the sensor, for example in order to identify the position of a pointer in front of a touch-sensitive screen.

The invention may further be applied to video surveillance or telemetry.

Existing CCD matrix optical sensors are relatively costly and the image formed on the pixels is read sequentially block by block. Processing the image is relatively complex because all the pixels must be stored.

There are also CMOS matrix sensors known as snapshot sensors, in which each pixel is associated with an analog memory. The pixels are relatively large and the memory may suffer high leakage of information under strong illumination.

Also, numerous technical solutions have been proposed for producing touch-sensitive screens that include a screen and a system for locating a pointer in the image of a detection plane associated with the screen, for example placed just in front of it.

Location systems relying on the use of optical components are particular suitable for relatively large screens. Light sources and sensors are disposed relative to the screen so that the pointer intercepts the light emitted by these sources or reflected by reflective surfaces disposed at the perimeter of the screen and forms an image on the sensors. Analyzing the image formed in this way makes it possible to determine the position of the object by triangulation.

FIG. 15 shows an example of a touch-sensitive screen disclosed in patent application US 2007/0089915. To identify the position of a pointer D in a detection plane 103, two matrix sensors 101 and 102 are disposed at respective corners of the screen. The Cartesian coordinates X and Y of the finger D in the detection plane 103 may be determined from angles a and p corresponding to the masking effect of the pointer D in the detection plane 103.

Touch-sensitive screens equipped with linear sensors are also known. Unlike touch-sensitive screens using matrix sensors, linear sensors must be disposed very precisely relative to the detection plane. A drawback of this configuration is the sensitivity of these sensors to play or to mechanical deformation encountered during fabrication or use such that the image of the pointer might be formed outside the sensor.

To palliate that problem, the linear sensors used have rectangular pixels with the long side oriented perpendicularly to the detection plane. A drawback of using rectangular pixels is the reduced sensitivity of the pixels because of a higher photodiode stray capacitance. Furthermore, such pixels collect more stray light.

The use of matrix sensors in known detection systems leads to more data processing than linear sensors, which makes touch-sensitive screens more costly.

Finally, matrix sensors incorporating a windowing function are known. The sensor receives as input a window address, for example the address of the top corner, and delivers as output the values of the pixels in the window. In the event of incorrect alignment, this window may still remain relatively large and thus considerably increase the number of pixels to be processed. Moreover, because the speed of reading a matrix sensor is not the same for rows and columns, the enlargement of the reading window in the vertical direction significantly increases the time taken to read an image.

Patent application US 2004/0155175 discloses a matrix sensor associated with reading means configured to read an image formed on the sensor pixel matrix. The reading means read the columns of the pixel matrix sequentially. Such a sensor does not allow parallel processing of the columns of pixels, and reading an image with a sensor of this kind can take a relatively long time.

There is a need for a new matrix sensor capable of simplifying the processing of data coming from the pixel matrix for some applications, such as touch-sensitive screens, videosurveillance, and telemetry.

There is also a need to improve further existing sensors in order to have sensors that are both precise and fast, at the same time as being of relatively low manufacturing cost.

One aspect of the invention provides a matrix optical sensor including:
a matrix of pixels, each pixel being identified by a row address and a column address; and
a programmable electronic circuit including a plurality of programmable reader units for reading the pixels;
each programmable reader unit being associated with at least one address of a column of pixels and being configured:
   to enable storage of at least one row address during a step of programming the sensor;
   to receive a row address, and
   for some read address values, to compare the received row address to the programmed row address, and if they are equal to enable reading of the value of the corresponding pixel.

The invention more particularly provides a matrix optical sensor including:
a plurality of programmable reader units for reading the pixels, each connected to at least one column of pixels and each being configured:
   to enable storage of at least one row address during a step of programming the sensor;
   to receive a row address; and
   for some received row address values, to compare said received row address to the programmed row address, and if they are equal to enable reading of the value of the corresponding pixel.

At least one row address is for example dedicated to a function other than reading the value of a pixel and the programmable reader unit receiving this row address as a read address is for example configured to enable execution of said function, which may make it possible to reduce the number of sensor control signals.

The expression “to enable reading” as used herein means that the programmable reader unit is capable of delivering the value of the pixel either to the exterior of the sensor or to another component of the sensor, for example with a view to storing it and/or processing it within the sensor, for example to subject it to differential processing. Reading may be effected firstly by addressing the row and then addressing the column.

The expression “value of the corresponding pixel” as used herein refers to the value of the pixel acquired directly by the sensor or the value after filtering for example.

The sensor of the invention makes it possible to program a selection of pixels and to read only the values of the programmed pixels, by using programmable reader units that may work in parallel.

For example, with an image of the detection plane including 256 rows of 1600 pixels, the invention makes it possible to avoid having to read each of the 256 rows of the image, and therefore accelerates processing.

The expression “row of pixels” as used herein refers to a line of pixels in the direction of the dimension of the matrix of pixels containing the greater number of pixels. The expression “column of pixels” as used herein refers to a line of pixels in the direction of the dimension of the matrix of pixels containing the lesser number of pixels. For example, with a sensor having 256×1600 pixels, the sensor is considered to have 256 rows of 1600 pixels and 1600 columns each of 256 pixels.

At least one programmable reader unit, notably each programmable reader unit, may be associated with only one pixel column address. In other words, the programmable reader unit may be connected to only one column of pixels.

As emerges below, the sensor may be integrated into a system for locating a pointer in an image of a detection plane formed on the sensor by detecting blocking by the pointer of light rays directed toward the sensor. This image may define straight-line segments having quite low angles of inclination relative to the rows of the sensor.

The image read may have only one dimension, i.e. be read for only one pixel per column. Such reading may be effected in parallel, i.e. simultaneously, by all the reader units.

At least one programmable reader unit, notably each programmable reader unit, may be associated with a plurality of pixel column addresses, for example consecutive column addresses, or, in other words, may be connected to a plurality of columns of pixels, for example two consecutive columns of pixels. This makes it possible to simplify further processing and also to simplify the construction of the sensor.

Thus in one embodiment there may be as many reader units as there are columns of pixels. In another embodiment there may be fewer reader units than columns of pixels, for example between two and ten times fewer reader units than columns of pixels, the number of reader units being greater than 1.

The number of rows of the matrix of pixels is for example equal to 2ⁿ and each programmable reader unit may be associated with n consecutive pixel column addresses. Accordingly, with 256 rows of pixels, 8 consecutive column addresses are for example associated with the same programmable reader unit.

The invention also makes it possible to reduce the sensor reading clock frequency, to the benefit of power consumption and stray electromagnetic radiation. The power consumed by a sensor of the invention is for example less than 100 milliwatts (mW) at a supply voltage of the order of 3.3 V.

The matrix sensor of the invention is for example produced in the form of a small electronic integrated circuit chip.

Each programmable reader unit includes, for example:
at least one memory register storing the row address programmed in the programmable reader unit;
a comparator receiving:
   at a first input the read address; and
   at a second input the row address programmed in the memory register; and
at least one buffer memory.

The comparator may be configured to compare the addresses at the first and second inputs and, if they are equal, to enable storage in the buffer memory of the value of the pixel the row address of which is programmed in the programmable reader unit.

When a programmable reader unit is associated with a plurality of pixel column addresses or, in other words, is connected to a plurality of columns of pixels, the programmable reader unit may include a single memory register, a single comparator for all said pixel column addresses, and a buffer memory for each pixel column address.

In a first embodiment, the programmable reader unit includes only one memory register, only one comparator, and at least one buffer memory.

If the programmable reader unit includes a plurality of buffer memories associated with the same column address or, in other words, connected to the same column, they may make it possible to store successively the values of the pixels identified by the same row and column addresses. This may make it possible to carry out differential processing between two images formed successively on the sensor, for example in order to eliminate the contribution of ambient light.

The sensor may include a differential amplifier for delivering a value corresponding to the difference of the values of a pixel at two successive times, which correspond for example to turning on and turning off the light source used to form the image of the detection plane on the sensor. In a second embodiment, the programmable reader unit includes a plurality of memory registers, a single comparator, and one or more buffer memories. During the programming step, the user may program different row addresses in each memory register, which may make it possible to read in the buffer memory or memories of the programmable reader unit the values of different pixels of the same column of pixels.

Each programmable reader unit includes for example two memory registers, which makes it possible to read for example pixels defining a closed or open loop pattern on the image formed on the sensor.

The programmable unit may further include more memory registers, for example four registers, in order to read pixels of an image of more complex shape formed on the sensor, for example defining a kidney-shaped pattern.

The sensor includes a matrix of photodetectors, one pixel being for example associated with one photodetector. Alternatively, one pixel may be associated with a plurality of photodetectors. These photodetectors may be produced using the complementary metal oxide semiconductor (CMOS) technology.

The matrix sensor may be configured to effect at least one binomial filtering operation in a column of the matrix of photodetectors, which may make it possible to smooth the distribution of the electric charges acquired by the photodetectors in the filtered direction.

Binomial filtering may make it possible to compensate disturbances occurring during operation of the matrix sensor, caused for example by mechanical stresses exerted on a screen with which the sensor is associated or by ambient temperature.

Binomial filtering may be effected with two different configurations. A first configuration connects two photodetectors of at least one column of the matrix with respective coordinates 2k and 2k+1 depending on the column that is filtered, k being a natural integer, for example with row addresses 2k and 2k+1.

In a second configuration binomial filtering is effected by connecting two photodetectors of at least one column of the matrix with respective coordinates 2k+1 and 2k+2 depending on the column filtered, k being a natural integer, for example with row addresses 2k+1 and 2k+2.

Binomial filtering may be effected with the first filtering configuration and then the second filtering configuration or vice-versa.

Alternatively, it is possible to use only the first configuration or only the second configuration.

A further alternative is to proceed to a plurality of binomial filtering operations with the above two configurations alternating, depending on the required degree of smoothing of the distribution of charges.

Depending on the required degree of smoothing, a plurality of filtering operations may be effected on the matrix of photodetectors.

The matrix sensor includes for example a plurality of switches, each connecting two adjacent photodetectors of the matrix of photodetectors, notably two adjacent photodetectors of the same column.

These binomial filtering operations may be activated by two signals. Alternatively, at least one row address dedicated to a function other than pixel value reading is dedicated to configuring binomial filtering as described above, and reception by the programmable reader unit of said address as a read address causes for example closing of the switches according to one of the filtering configurations described above.

One pixel row address is for example dedicated to each binomial filtering configuration.

Another aspect of the invention provides a system for locating a pointer in the image of a detection plane, including at least one matrix sensor as defined above.

The sensor is for example configured to acquire an image of a detection plane and the pixels having their row address stored in the programmable reader units are the pixels on which the image of the detection plane is formed.

Because the pointer blocks light from reaching different pixels depending on its location, analyzing the read pixels makes it possible to detect the position of the pointer in the detection plane.

The location system is for example integrated into a screen to form a touch-sensitive screen and the image of the detection plane formed on the sensor is for example that of one or more light sources distributed around the screen or their reflection by a reflector situated at the edge of the screen.

For example a large number of light-emitting diodes (LEDs) may be used to provide a uniform and continuous emissive surface. The presence of a pointer in the proximity of the screen masks this emissive surface, forming an image of the pointer on some pixels.

The screen into which the location system is integrated preferably includes one or more LEDs situated in the vicinity of the optical axis of the sensors and illuminating the edges of the screen, which are provided with catadioptric reflectors. The light from the LEDs is reflected toward each sensor with a given luminous efficiency. The presence of a pointer in the vicinity of the screen causes a substantial reduction of this efficiency and masks the sensor.

The programmable reader units make it possible to read only the value(s) of the pixel(s) of the sensor that is/are liable to change as a function of the position of the pointer in the image of the detection plane, and not all the pixels of the sensor, thereby reducing processing time and the requirement for random-access memory. Not all the values of the pixels of the sensor need to be saved. This reduces the cost of the location system.

The location system advantageously includes two matrix sensors of the invention, and location may be effected by a triangulation calculation.

The programmable reader unit may receive as input, i.e. as a read address, only the row addresses of pixels on which the image of the detection plane is formed, which may make it possible to avoid processing the rows of pixels of the sensor on which there is no chance of forming the image of the pointer used to locate the pointer.

Another aspect of the invention provides a touch-sensitive screen including:
a screen; and
a location system as defined above.

A further aspect of the invention provides a method of reading a selection of pixels within a matrix of pixels, wherein each pixel is identified by a row address and a column address and the selected row addresses are programmed in programmable reader units, each associated with, or in other words connected to, at least one column of pixels, in which method:
at least one read address is supplied as input to the programmable reader units;
for some read address values, said row address received as input in this way is compared to at least one row address programmed in each programmable reader unit and if they are equal the value of the pixel having the programmed row address is stored in a buffer memory.

At least one row address is for example dedicated to a function other than reading the value of pixels and the programmable reader unit receiving this row address as a read address is for example configured to enable execution of said function.

A single row address may be programmed for each programmable reader unit, for example during a sensor calibration stage.

Alternatively, a plurality of row addresses is programmed for each programmable reader unit and the read address received as input is compared to these programmed addresses in the programmable reader unit to determine whether it is equal to one of them. The programmable reader unit may include as many buffer memories as there are programmed row addresses.

The programmable reader unit may be reprogrammed on the fly. Once the value of the pixel corresponding to the row address programmed in the memory register of the programmable reader unit has been stored in a buffer memory of this programmable reader unit, the user may program a new row address in the memory register, the value of the pixel identified by this new row address being subsequently stored in the same buffer memory of the programmable reader unit, after the previous data is read and deleted, or in another buffer memory of the programmable reader unit. This may make it possible to read the value of a plurality of pixels of the same column associated with a programmable reader unit.

The matrix of pixels is associated with a matrix of photodetectors and the method may include a photodetector binomial filtering step as defined above before the step of providing a read address to the programmable reader units.

At least one row address is for example dedicated to configuring binomial filtering and, during the binomial filtering step, said row address is sent as a read address to at least one programmable reader unit, for example.

A further aspect of the invention provides a method of locating a pointer in the image of a detection plane, wherein:
acquisition of the image of the detection plane by means of a matrix of photodetectors is enabled, each pixel of the image being identified in the image of the detection plane by a row address and a column address; and
reading of a selection of pixels of the image of the detection plane by the above method is enabled.

The method may include the steps of:
acquiring a first image of at least part of the detection plane, notably the whole of detection plane, when the observation field of the matrix of photodetectors is illuminated by an artificial light source;
acquiring a second image of said part of the detection plane in the absence of illumination of the observation field of the matrix of photodetectors by the artificial light source; and
reading the first and second images differentially.

Such differential reading makes it possible to reduce noise caused by ambient lighting.

By way of example, in order to acquire the first and second images, an iterative process is used, acquiring only a portion of the image of the detection plane on each iteration during an elementary cycle of turning on and turning off the artificial light source. On each iteration, only one row of pixels of the image of the detection plane is acquired, for example.

An iterative acquisition method makes it possible for example to expose to the light from the artificial light source the photodetectors associated with the row to be acquired for only a shorter time, which may prove desirable if the brightness of the artificial light source is high, and this may make it possible to prevent saturation of the photodetectors.

Alternatively, a plurality of rows of pixels of the image of the detection plane is acquired on each iteration.

Another alternative is, for the first and second images, and during a single elementary cycle of turning on and turning off the artificial light source, to acquire the whole of the image of the detection plane, which may make it possible to reduce the artificial light source on/off ratio and to obtain light pulses of higher energy.

The artificial light source includes for example at least one light-emitting diode.

Another aspect of the invention provides, in combination with the above features, a matrix optical sensor comprising:
a two-dimensional matrix of pixels read first by row address and then by column address;
a plurality of reader units each connected to at least one column of pixels, each reader unit storing a reading result selectively for one or more given row addresses of the sensor being configured to make it possible to obtain after a scan of all or part of the rows of the matrix of pixels a one-dimensional image corresponding to a given row of pixels of the pixel matrix.

The invention can be better understood after reading the following description of non-limiting embodiments of the invention and examining the appended drawings, in which:

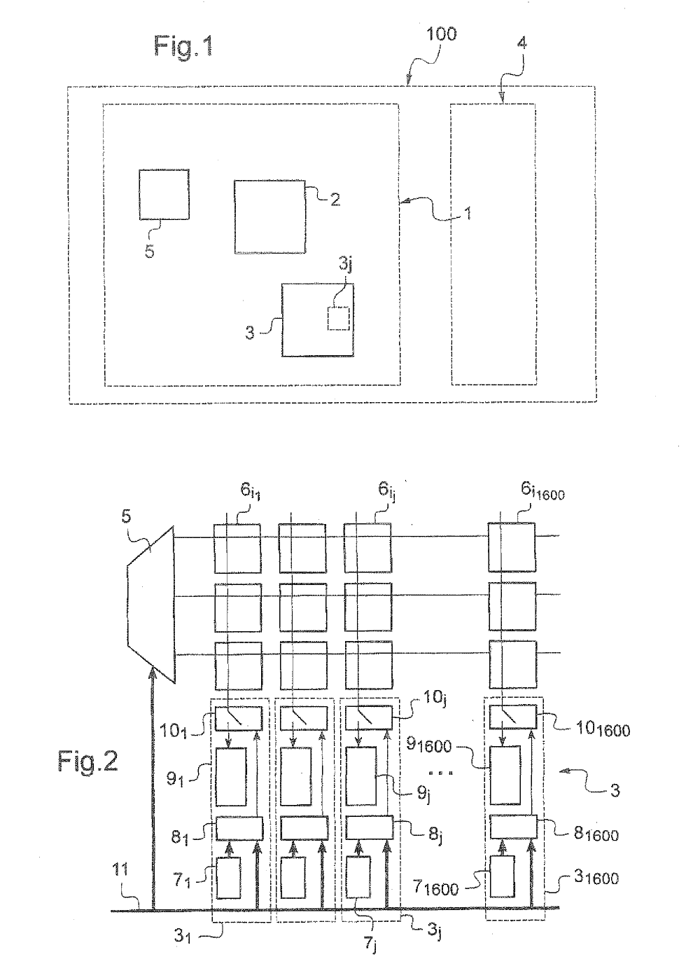

FIG. 1 shows diagrammatically an example of a matrix sensor of the invention;

FIG. 2 shows diagrammatically a plurality of programmable reader units of the invention;

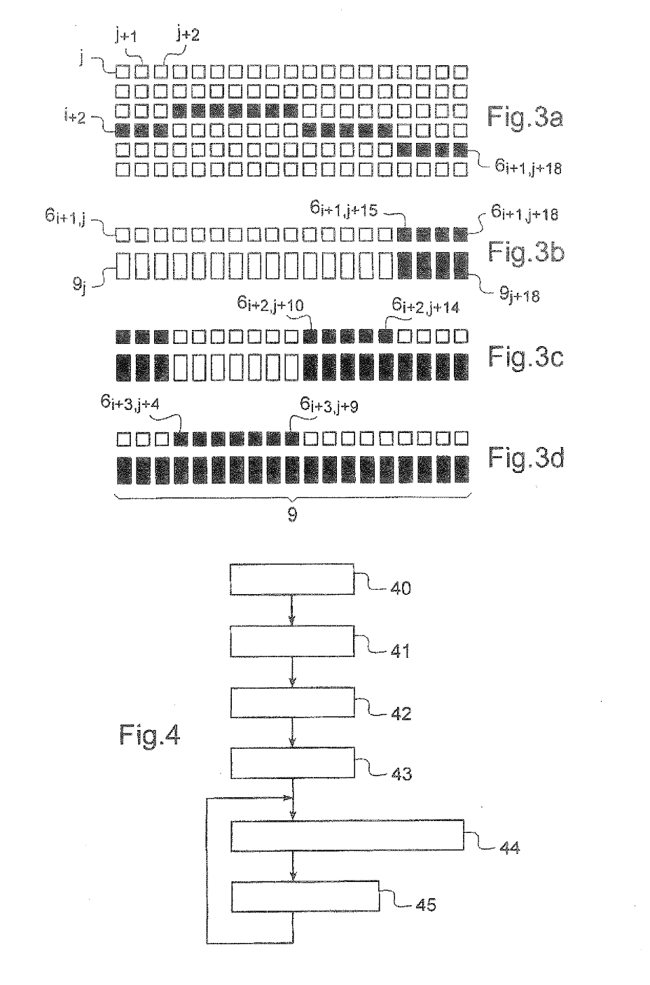

FIG. 3a shows an example of an image of the detection plane formed on part of the matrix sensor in the presence of a pointer;

FIGS. 3b to 3d show different steps of the process of locating the pointer in the image of the detection plane by the location system;

FIG. 4 shows diagrammatically different steps of a method of locating pointer in the image of the detection plane;

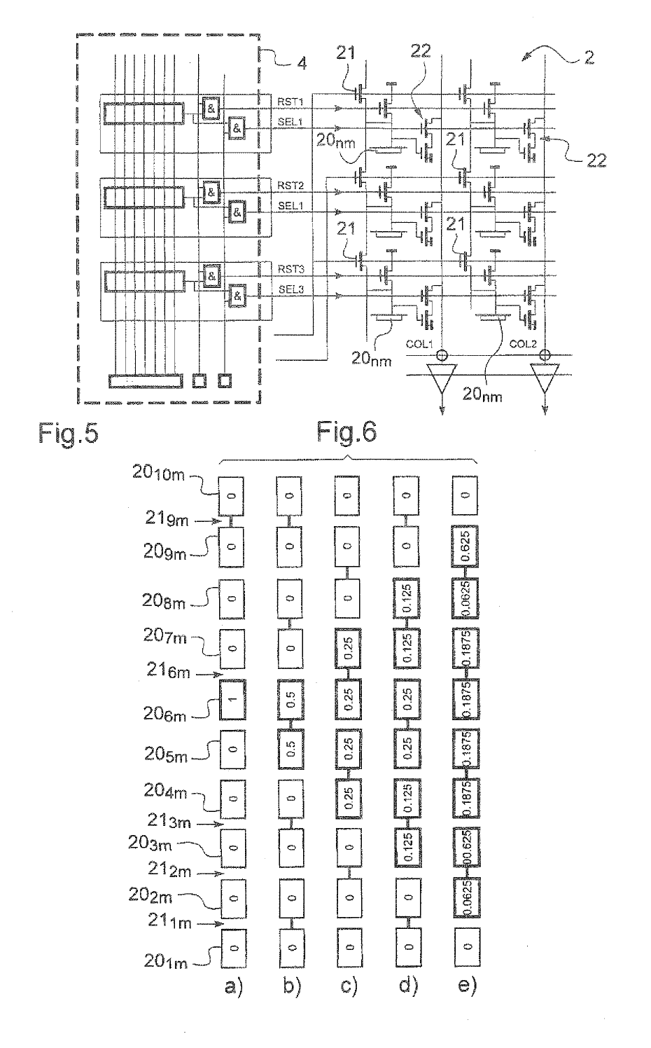

FIG. 5 shows elements of an example of a matrix sensor of the invention;

FIGS. 6a to 6e show steps of an example of binomial filtering;

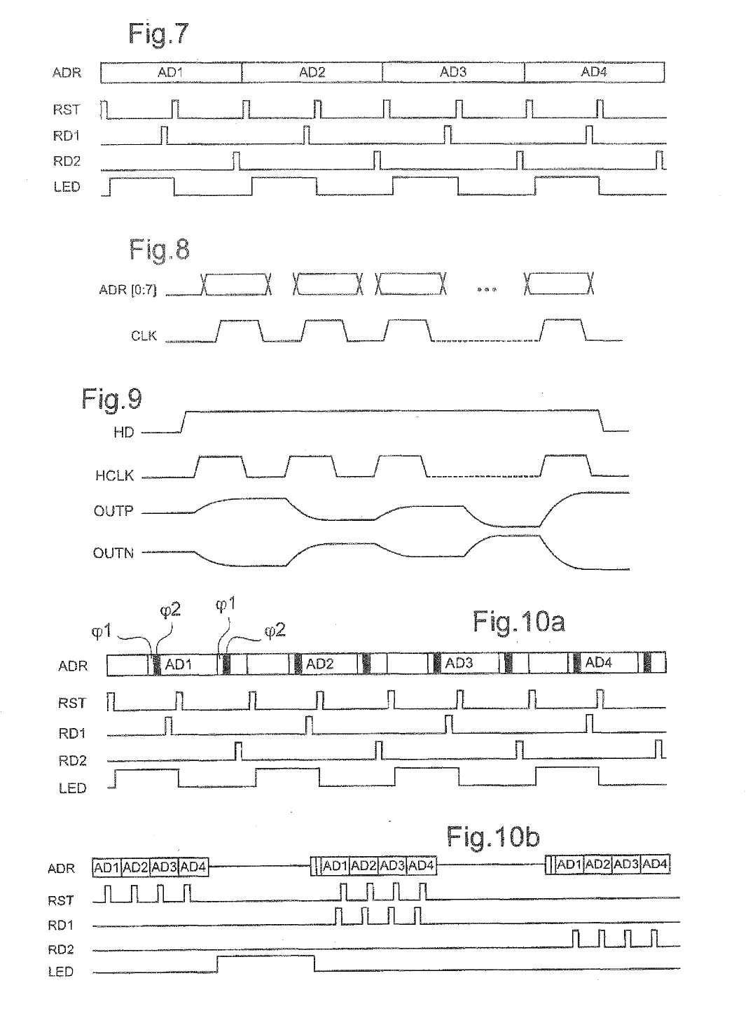

FIG. 7 shows an example of differential reading;

FIG. 8 shows an example of a method of programming a programmable reader unit;

FIG. 9 is a timing diagram showing an example of reading buffer memories;

FIG. 10a is a timing diagram showing a first example of differential reading in accordance with the invention;

FIG. 10b is a timing diagram showing a second example of differential reading in accordance with the invention;

FIG. 11 is an example of integrating a location system of the invention into a device;

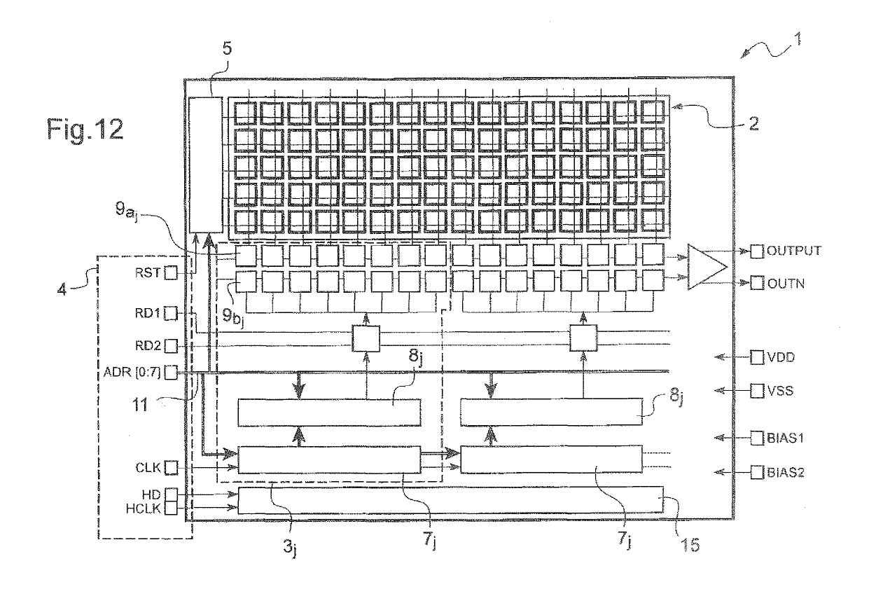

FIG. 12 shows diagrammatically a variant of the matrix sensor shown in FIG. 5;

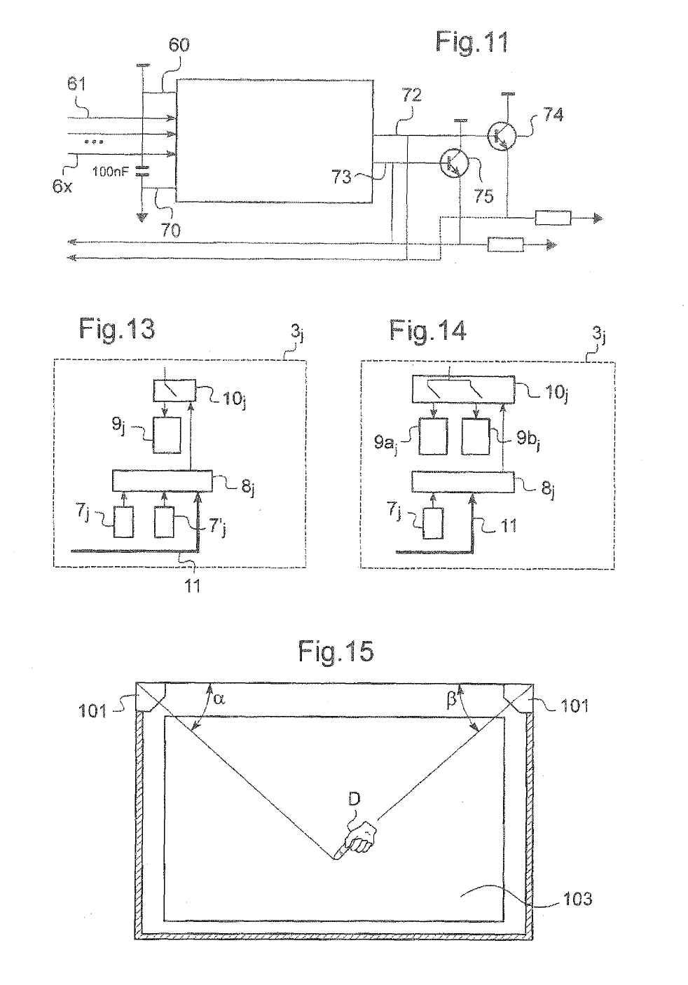

FIGS. 13 and 14 show other examples of programmable reader units of the invention; and

FIG. 15 shows an example of detecting the position of a finger on a prior art touch-sensitive screen.

### Matrix Sensor

FIG. 1 shows very diagrammatically an example of a matrix sensor 1 of the invention.

This sensor 1 may be integrated into a location system 100, and in the example shown it includes an image acquisition device 2, a programmable electronic circuit 3 including a plurality of programmable reader units 3ⱼ, and a decoder 5.

The matrix sensor 1 of the invention is for example integrated into a small integrated circuit, for example one of size less than 25 square millimeters (mm²).

The resolution of the sensor 2 is for example 256 rows of 1600 pixels and each pixel has for example a size of 5 micrometers (μm), but the invention is not limited to any particular resolution or pixel size. The pixels are for example pixels with no memory, known as active pixels.

The sensor 1 exchanges data with a digital processor unit 4 that includes, for example, a microprocessor and a random-access memory.

The decoder 5 is for example produced using conventional logic gates, being configured for example to convert a natural binary code into a vector of binary signals of which only one has the value “1”. This binary “1” makes it possible to select the row of pixels to be read. The decoder 5 receives the address of a row to read from the processor unit 4 via a bus 11, as shown in FIG. 2.

In the FIG. 2 example, a programmable reader unit 3ⱼ is associated with a single pixel column address.

Each programmable reader unit 3ⱼ includes in the example shown in this figure a programmable memory register 7ⱼ, a comparator 8 associated with the memory register 7ⱼ, a buffer memory 9ⱼ, and an electronic switch 10ⱼ.

As may be seen, each comparator 8ⱼ may have two inputs: a first input connected to the bus 11 and a second input connected to the memory register 7ⱼ of the programmable reader unit 3ⱼ.

In the example described here, each memory register 7ⱼ, each comparator 8ⱼ, and each buffer memory 9ⱼ is associated with a single column of pixels.

FIGS. 13 and 14 show other examples of programmable reader units 3ⱼ.

In the FIG. 13 example, a programmable reader unit 3ⱼ includes two memory registers 7ⱼ and 7_{j′}, a comparator 8ⱼ, a buffer memory 9ⱼ, and an electronic switch 10ⱼ.

The invention is not limited to a particular number of memory registers 7ⱼ in each programmable reader unit 3ⱼ. Each programmable reader unit 3ⱼ may include more than two memory registers 7ⱼ.

As shown in FIG. 14, each programmable reader unit 3ⱼ may also include a memory register 7ⱼ, a comparator 8ⱼ, two buffer memories 9aⱼ and 9bⱼ, and an electronic switch 10ⱼ. The invention is not limited to a particular number of buffer memories 9ⱼ in each programmable reader unit. Each programmable reader unit may include more than two buffer memories 9ⱼ.

In another variant that is not shown, each programmable reader unit includes a comparator, a plurality of memory registers, and a plurality of buffer memories.

FIG. 5 shows an example of an image acquisition device of the invention.

This acquisition device 2 includes for example a matrix of detector elements that in the example described here are photodetectors 20ₙₘ.

The sensor 1 also includes a plurality of switches 21, for example field-effect transistors 21, connecting two adjacent photodetectors in a column of the matrix sensor and a plurality of switches 22 for reading the charge acquired by the photodetectors 10ₙₘ.

The sensor 1 includes for example, as shown in FIG. 11, a plurality of inputs 60, 61 to 6x and 70.

The input 60 is for example connected to a power supply, the inputs 61 to 6x are for example connected to a processor of the device into which the sensor 1 is integrated, and the input 70 is for example connected to ground.

As may be seen in FIG. 11, the input 60 and the input 70 may be connected by a decoupling capacitor.

The system 1 includes for example two outputs 72 and 73 connected to respective transistors 74 and 75.

### Application to Locating a Pointer in Front of a Touch-Sensitive Screen

There is described below with reference to FIGS. 3a to 3d and FIG. 4 an example of an application of the invention to locating a pointer in the image of a detection plane of a touch-sensitive screen using a location system 100 including a sensor 1 including programmable reader units 3 as shown in FIG. 2.

In FIG. 3a there are shown only six rows and 19 columns of the matrix of pixels of the sensor. In this example, columns are numbered from left to right and rows from the bottom upwards.

The dark pixels correspond to the presence of the pointer blocking a light source. The pixels enabling the pointer to be located in the image of the detection plane for the columns with address j and j+2 are all situated on the row with address i+2 and in the example shown are respectively designated 6_{i+2, j}, 6_{i+2, j+1}, and 6_{i+2, j+2}.

As may be seen in FIG. 3a, the values of all the pixels making it possible to locate the pointer in the image of the detection plane may fill a one-dimensional array.

### Programming of Reader Units Prior to Locating the Pointer

During an initialization step 40 shown in FIG. 4, the digital processor unit 4 causes information previously stored in the memory registers 7ⱼ, of each programmable reader unit 3ⱼ to be deleted.

During the step 41, the digital processor unit 4 proceeds to scan each row of the image of the detection plane and in the step 42 determines for each column of pixels the row address of the pixel corresponding to the image of the detection plane.

In the step 43, there is programmed into each of the memory registers 7ⱼ₊₁ to 7ⱼ₊₁₉ the row address of the pixel of each column making it possible to locate the pointer in the image of the detection plane. In the example shown the row address “i+2” is stored in the registers 7ⱼ₊₁, 7ⱼ₊₂, and 7ⱼ₊₃.

FIG. 8 shows one example of programming a row address in a memory register 7ⱼ in the step 43.

The digital processor unit 4 sends the memory register 7ⱼ associated with the column of pixels with column address j via a bus, not shown, a signal ADR [7:0] corresponding to the row address of the pixel of this column to be programmed.

With an image comprising 256 rows, the row address is coded on eight bits and the memory register 7ⱼ stores this row address sequentially, bit by bit. The memory register receives the bits of the coded address successively, each bit being stored in the memory register on a rising edge of the clock signal CLK, as shown in FIG. 8. Storage in a memory register 7ⱼ is effected at a rate in excess of 12 megahertz (MHz), for example.

### Storing Pixel Values to Locate the Pointer in the Image of the Detection Plane

Once the row address of each of the pixels 6ᵢₖ making it possible to locate the pointer in the image of the detection plane has been programmed in each memory register 7ⱼ to 7ⱼ₊₁₈, in the step 44 the digital processor unit 4 sends via the bus 11 to the decoder 5 and to each programmable reader unit 3ⱼ to 3ⱼ₊₁₈ an address for reading pixels of the image, this read address corresponding to a row address.

In the example described here, the first read address sent in this step 44 corresponds to the lowest row address associated with one or more pixels on which the image of the detection plane is formed.

Each comparator 8ⱼ compares this read address received via a first input to the row address programmed in the step 43 in the memory register 7ⱼ with which it is associated and that it receives via a second input.

If the two values compared are equal, the comparator 8ⱼ acts on the switch 10ⱼ to enable storage of the value of the corresponding pixel in the buffer memories 9ⱼ.

In the FIG. 3b example, when the read address “i+1” is received by the programmable reader units 3ⱼ to 3ⱼ₊₁₈, and thus by the comparators 8ⱼ to 8ⱼ₊₁₈, each comparator 8ⱼ compares this value with the row address programmed in the memory register 7ⱼ. In the present example, the comparators of the columns numbered j+15 to j+18 determine that the values received at the first and second inputs are equal.

The values of the pixels 6_{i+1, j+15}, 6_{i+1, j+16}, 6_{i+1, j+17} and 6_{i+1, j+18} are then stored in the buffer memories 9₁₅ to 9₁₈ in the step 45.

The steps 44 and 45 are then repeated, the digital processor unit 4, by incrementing the row number, sending the decoder 5 and the programmable reader units 3ⱼ to 3ⱼ₊₁₈ the next reading address via the bus 11.

In the example described here, the read address “i+2” is sent, and while both the comparators 8ⱼ to 8ⱼ₊₂ and also the comparators 8ⱼ₊₁₀ to 8ⱼ₊₁₄ have equal first and second input values, the values of the corresponding pixels are stored in the buffer memories 9ⱼ to 9ⱼ₊₂ and 9ⱼ₊₁₀ and 9ⱼ₊₁₄.

The read address “i+3” is then sent to the decoder 5 and to the programmable reader units 3ⱼ to 3ⱼ₊₁₈ via the bus 11 and the process continues in a similar manner to that described above, which leads to storage in the buffer memories 9ⱼ₊₄ to 9ⱼ₊₉ of the values of the pixels 6_{i+3, j+4} to 6_{i+3, j+9}.

The values of the pixels making it possible to locate the pointer in the image of the detection plane are then read in the set 9 of buffer memories 9ⱼ to 9ⱼ₊₁₈.

The invention is not limited to the use of one programmable reader unit 3ⱼ per column of pixels. Thus a programmable reader unit 3ⱼ may be associated with a plurality of consecutive columns of pixels, notably when the pixels making it possible to locate the pointer in the detection plane define a plurality of segments, each having a low or zero inclination angle relative to the rows of the matrix sensor 2. The association of a single programmable reader unit 3ⱼ with a plurality of consecutive columns of pixels of the image of the detection plane may make it possible to simplify the location system. Only one row address may be programmed in the memory register of the programmable reader unit associated with these columns of pixels.

In other variants, the programmable reader units are as shown in FIGS. 13 and 14.

### One-Dimensional Binomial Filtering of the Matrix Sensor

The arrangement of the switches 22 within the acquisition device 2 makes it possible to carry out one-dimensional binomial filtering of the matrix of photodetectors, for example filtering along each column, known as vertical filtering.

In the FIG. 5 example, the switches 21 connect the adjacent photodetectors 20ₙₘ in the matrix in a column and make it possible to apply vertical filtering.

The invention makes it possible to apply binomial filtering in two configurations, as explained below with reference to FIGS. 6a to 6e.

The photodetectors are numbered 20₁ₘ to 20₁₀ₘ and two adjacent photodetectors are connected by switches 21ₖₘ. The switches 21₁ₘ, 21₂ₘ, 21₃ₘ, . . . , 21₉ₘ connect the respective photodetectors 20₁ₘ and 20₂ₘ, 20₂ₘ and 20₃ₘ, . . . , 20₉ₘ and 20₁₀ₘ.

FIG. 6a shows the photodetectors 20ₙₘ after acquisition of an image.

As may be seen, only the photodetector 20₆ₘ has stored a charge which, for the purposes of the example, is equal to one.

In the first filtering configuration shown in FIG. 6b, the switches 21_{2k+1,m} with coordinate 2k+1 along the filtering dimension, k being a natural integer, are closed to connect the photodetectors 20_{2k+1,m} and 20_{2k+2,m} with coordinates 2k+1 and 2k+2 along the filtering dimension, for example vertically within a column.

The charge acquired by a photodetector 20ₙₘ is calculated by summing the charges acquired by each of the photodetectors connected by a switch and dividing that sum by 2.

As may be seen in FIG. 6b, following this operation, the photodetectors 20₅ₘ and 20₆ₘ both have a charge equal to 0.5, the charge no longer being carried only by the photodetector 20₆ₘ as it was before filtering.

Depending on the required degree of smoothing of the distribution of charges, a second filtering configuration shown in FIG. 6c may be applied to the photodetectors of the matrix.

In this second filtering configuration, the switches 21_{2k,m} with coordinate 2k along the filtering dimension, k being a natural integer, are closed to connect the photodetectors 20_{2k,m} and 20_{2k+1,m} with coordinates 2k and 2k+1 along the filtering dimension.

The charge acquired by a photodetector 20ₙₘ is calculated, as in the first configuration, by summing the charges acquired by each of the photodetectors connected by a switch and dividing that sum by 2.

As may be seen in FIG. 6c, after this operation, each of the photodetectors 20₄ₘ to 20₇ₘ has a charge equal to one quarter of the charge initially carried by the single photodetector 20₆ₘ.

If necessary, binomial filtering may be effected again using the first configuration, as shown in FIG. 6d, and then using the second configuration, as shown in FIG. 6e, so as to smooth even further the distribution of charges.

By way of example, each of the two filtering configurations is coded by a respective address φ1 or φ2. In the example described here, φ1 and φ2 are particular addresses of rows of pixels dedicated to binomial filtering. For an image with 256 rows, for example in hexadecimal code, φ1 corresponds to the address 00 and φ2 to the address FF.

The digital processor unit 4 sending one of these addresses to the image acquisition device 2 and to the programmable reader units brings about closing of the switches 21_{n,2k} with index 2k along the filtering dimension or 21_{n,2k+1} with index 2k+1, depending on the filtering configuration.

### Differential Reading

The invention may equally make it possible to eliminate ambient light by using differential reading.

FIG. 7, in timing diagram form, shows an example of differential reading in accordance with the invention:
a first image of a portion of the detection plane is acquired when the observation field of the matrix of photodetectors is illuminated by an artificial light source;
a second image of the same portion of the detection plane is acquired with no illumination by the artificial light source; and
noise linked to the ambient lighting is eliminated by subtracting the second image from the first image, for example using a differential amplifier.

Even if it is intense, the ambient lighting remains largely stationary, so that if the image-acquisition speed is high the influence of the ambient light may be greatly attenuated after subtracting the second image from the first.

In the situation shown in FIG. 7, differential reading is applied to a row of pixels at a time, but it could be effected differently.

By way of example, the digital processor unit 4 is configured to send the acquisition device 2 and the programmable electronic circuit 3 the address AD1 of a first row of pixels of the image of the detection plane to be processed.

The digital processor unit 4 is capable of causing any charges acquired previously by the photodetectors 20 to be deleted, this deletion of charges corresponding in the timing diagram to activating the signal RST.

The digital processor unit 4 may then illuminate the field of observation of the acquisition device 2 by means of the artificial light source. By way of example, this is a light-emitting diode, in a state that is shown in the FIG. 7 timing diagram by the signal LED.

The digital processor unit 4 then causes the image acquisition device 2 to acquire a first image of the processed row and the programmable electronic circuit to store the values of the pixels of the acquired row, as shown for example in one of FIGS. 3b to 3d, which corresponds in the timing diagram to activating the signal RD1.

The digital processor unit may then delete the charges acquired by the photodetectors during the preceding step and turn off of the artificial light source.

The digital processor unit 4 may then cause the image acquisition device to acquire a second image of the processed row and the values of the pixels of the acquired row to be stored by the programmable electronic circuit 3, which corresponds in the timing diagram to activating the signal RD2.

The digital processor unit 4 then sends the address of the next row of pixels to be processed for example and the steps described above are repeated.

FIG. 9, in timing diagram form, shows an example of differential reading a matrix sensor 1 of the invention.

In this example, each programmable reader unit 3ⱼ is associated with a column of pixels and is as shown in FIG. 14, including a memory register 7ⱼ, a comparator 8ⱼ, and two buffer memories 9aⱼ and 9b₁.

By way of example, the set 9a formed by the buffer memories 9aⱼ of each programmable reader unit 3ⱼ contains the values of pixels stored by the above-described method during processing of the first image acquired with illumination by the artificial light source.

By way of example, the set 9b formed by the buffer memories 9bⱼ of each programmable reader unit 3ⱼ contains the values of pixels stored by the above-described method during processing of the second image acquired without illumination by the artificial light source.

In the example described here, the invention uses sequential reading of the content of the memory sets 9a and 9b by a shift register 15 that is in a state as shown in FIG. 9 by the signal HD. Setting this signal HD to 0 deletes the information previously acquired by the shift register.

The shift register proceeds to read the content of a buffer memory 9aⱼ or 9bⱼ on reception of the clock signal HCLK.

The FIG. 9 timing diagram also shows the signal OUTP that corresponds to reading the set of memories 9a associated with the first image, and the signal OUTN that corresponds to reading the set 9b of memories associated with the second image.

The information read in the sets of memories 9a and 9b may then be subjected to a subtraction operation, for example using a differential amplifier connected to the read buses of the memory sets 9a and 9b.

According to the invention, the differential reading may be implemented by acquiring only one row of pixels of the first image and of the second image during a cycle of turning on and turning off the artificial light source, and by proceeding iteratively for each row of pixels to be acquired.

FIG. 10a shows a timing diagram corresponding to one such example of differential reading.

In the example concerned, the digital processor unit 4 first deletes charges previously acquired by the photodetectors 20 of the acquisition device 2 and activates the artificial light source, which correspond in the FIG. 10a timing diagram respectively to activating the signal RST and the signal LED.

The digital processor unit 4 then sends the acquisition device 2 and the programmable electronic circuit 3 the addresses φ1 and φ2 associated with the two vertical binomial filtering configurations.

The digital processor unit 4 then sends the acquisition device 2 and the programmable electronic circuit 3 the address AD1 of the row of pixels to be treated and then activates the signal RD1.

Activating the signal RD1 causes in succession:
acquisition by the acquisition device 2 of the row of address AD1 of the first image;
vertical binomial filtering of the electric charge stored by the photodetectors of the acquisition device in the two configurations, in accordance with the previously received addresses φ1 and φ2; and
reading by the programmable electronic circuit 3 of the values of the pixels of this row, enabling the pointer to be located in the image of the detection plane. The values of these pixels are stored in the buffer memories 9aⱼ, as described above.

The digital processor unit 4 then deletes the charges previously acquired by the photodetectors and turns off the artificial light source, which correspond in the FIG. 10a timing diagram respectively to activating the signal RST and de-activating the signal LED.

The digital processor unit then sends the sensor 1 and the programmable electronic circuit 3 the addresses φ1 and φ2 associated with the two vertical binomial filtering configurations and then activates the signal RD2.

Activating the signal RD2 causes in succession:
acquisition by the acquisition device 2 of the row of address AD1 of the second image;
vertical binomial filtering of the electric charge stored by the photodetectors of the acquisition device in the two configurations, in accordance with the previously received addresses φ1 and φ2; and
reading by the programmable electronic circuit 3 of the values of the pixels of this row, enabling the pointer to be located in the image of the detection plane. The values of these pixels are stored in the buffer memories 9bⱼ, as described above.

Once the two images of the row of pixels at address AD1 have been acquired, the digital processor unit processes iteratively the rows of pixels with addresses AD2, AD3, etc.

The invention is not limited to binomial filtering in two configurations before processing the first and second images. It could instead be preceded by binomial filtering in only one of the two configurations. A further alternative is for no binomial filtering to be effected before acquisition of the first and second images.

In the example shown in FIG. 10a, a cycle of turning on and turning off the artificial light source corresponds to the acquisition of first and second images of only one row of pixels.

Another example of differential filtering in accordance with the invention is shown in FIG. 10b. In this example, a single cycle of turning on and turning off the artificial light source enables acquisition of all the rows of pixels.

As shown in FIG. 10b, charges previously acquired by each photodetector are first deleted by sending the address of each row and activating the signal RST for each row.

The digital processor unit 4 then turns on the artificial light source and then turns it off. Once the source is turned off, the addresses φ1 and φ2 are sent, in a similar way to that described with reference to FIG. 10a.

The address AD1 is then sent, which causes reading of the pixels of the row with address AD1, enabling the pointer to be located in the image of the detection plane, as described with reference to FIGS. 3a to 3d, after which the signal RST is activated, causing deletion of the acquired electric charges.

The other row addresses are then sent successively and the steps described above are repeated for each row address sent.

The first image is acquired in this way after a single cycle of turning on and turning off the artificial light source.

The addresses φ1 and φ2 are then sent again, as are the row addresses, which enables acquisition of the second image.

Other Embodiment of a Location System

The invention is not limited to the examples that are described above.

For example, different features of the invention may be combined, as in the FIG. 12 example.

In this example, each programmable reader unit 3ⱼ is associated with a plurality of successive column addresses, eight addresses in the example described here.

Each programmable reader unit 3ⱼ includes a memory register 7ⱼ, a comparator 8ⱼ, and eight pairs of buffer memories 9aⱼ to 9aⱼ₊₇ and 9bⱼ to 9bⱼ₊₇.

A row address common to the eight columns of pixels with a column address ranging from j to j+7 is programmed in the memory register 7ⱼ.

A read address sent by the digital processor unit 4 via the bus 11 is received at its input by each programmable reader unit 3ⱼ, which forwards it to the comparator 8ⱼ, in turn verifying whether the received address is equal to the address programmed in the memory register 7ⱼ associated with the eight columns with a column address ranging from j to j+7.

As may be seen, the device shown in FIG. 12 includes two buffer memories 9aⱼ and 9bⱼ associated with each column, the buffer memories 9aⱼ and 9bⱼ respectively relating to a first image and a second image of the detection plane.

The expression “including a” as used herein should be understood as being synonymous with the expression “including at least one”, unless the contrary is specified.

1.-16. (canceled)

17. A matrix optical sensor including:
a matrix of pixels, each pixel being identified by a row address and a column address; and
a plurality of programmable reader units for reading the pixels, each connected to at least one column of pixels and each being configured:
to enable storage of at least one row address during a step of programming the sensor;
to receive a row address; and
for some received row address values, to compare said received row address to the programmed row address, and if they are equal to enable reading of the value of the corresponding pixel.

18. A sensor according to claim 17, at least one row address being dedicated to a function other than reading the value of a pixel and the programmable reader unit receiving that row address as a read address being configured to enable execution of said function.

19. A sensor according to claim 17, wherein at least one programmable reader unit is connected to only one pixel column address.

20. A sensor according to claim 19, wherein each programmable reader unit is connected to only one pixel column address.

21. A sensor according to claim 17, wherein at least one programmable reader unit, is connected to a plurality of pixel column addresses.

22. A sensor according to claim 21, wherein each programmable reader unit is connected to a plurality of pixel column addresses.

23. A sensor according to claim 22, wherein each programmable reader unit is connected to eight consecutive column addresses.

24. A sensor according to claim 17, wherein each programmable reader unit includes:
at least one memory register storing the row address programmed in the programmable reader unit;
a comparator receiving:
at a first input the read address; and
at a second input the row address programmed in the memory register or registers; and
at least one buffer memory.

25. A sensor according to claim 24, wherein the comparator is configured to compare the addresses at the first and second inputs and, if they are equal, to enable storage in the buffer memory or memories of the values of the pixel or pixels the row address of which is programmed in the programmable reader unit.

26. A sensor according to claim 17, including a plurality of photodectors and a plurality of switches, each of the switches being connected to two adjacent photodetectors.

27. A location system for locating a pointer in the image of a detection plane, including at least two sensors according to claim 17.

28. A touch-sensitive screen including a screen and a location system according to claim 27.

29. A method of reading a selection of pixels within a matrix optical sensor according to claim 17, wherein each pixel is identified by a row address and a column address and the row addresses of the selected pixels are programmed into programmable reader units each connected to at least one column of pixels, in which method:
at least one row address is supplied as input to the programmable reader units;
for some row address values received as input, said row address received as input in this way is compared to at least one row address programmed in each programmable reader unit and if they are equal the value of the pixel having the programmed row address is stored in a buffer memory.

30. A method according to claim 29, wherein the matrix pixels is associated with a matrix of photodetectors and said matrix of photodetectors is binomially filtered in one direction of said matrix of photodetectors before providing read addresses to the programmable reader units.

31. A method according to claim 30, wherein:
the binomial flitering may be carried out in two different configurations, two photodetectors of the matrix sensor with respective coordinates 2k and 2k+1 in the filtered direction being connected in the first filter configuration and two photodetectors of the matrix sensor with respective coordinates 2k+1 and 2k+2 in the filtered direction being connected in the second filter configuration, k being a natural integer; and
filtering is carried out in at least one of the filter configurations.

32. A method of locating a pointer in the image of detection plane, comprising:
enabling acquisition of the image of the detection plane by means of a matrix of photodetectors, each pixel of the image being identified in the image of the detection plane by a row address and a column address; and
enabling reading of a selection of pixels of the image of the detection plane by the method of claim 29.

33. A method according to claim 32, wherein:
a first image of at least one part of the detection plane is acquired when the observation field of the matrix of photodetectors is illuminated by an artificial light source; and
a second image of at least one part of the detection plane is acquired that differs from the first image only in the absence of illumination of the observation field of the matrix of photodetectors by the artificial light source and the first and second images are read differentially.

34. A method according to claim 33, wherein an iterative process is used to acquire the first image and the second image of the detection plane, there being acquired on each iteration, during an elementary cycle of turning on and turning off the artificial light source, only part of the image of the detection plane.

35. A method according to claim 34, wherein an iterative process is used to acquire the first image and the second image of the detection plane, there being acquired on each iteration, during an elementary cycle of turning on and turning off the artificial light source, only the pixels associated with the same row address in the image of the detection plane.

36. A method according to claim 33, wherein a first image and a second image of the whole of the detection plane are acquired during a single elementary cycle of turning on and turning off the artificial light source.
